(19) United States
(12) Patent Application Publication
(10) Pub. No.: US 2004/0101158 A1
(43) Pub. Date: May 27, 2004

(54) System and methodology for authenticating trading cards and other printed collectibles

(75) Inventor: Michael A. Butler, Webster, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/305,329

(22) Filed: Nov. 26, 2002

(51) Int. Cl. G06K 9/00

(52) U.S. Cl. 382/100

(57) ABSTRACT

A proposed system and method for validation and confirmation of the authenticity of trading cards or other printed collectibles. By providing suitable embedded code as authentication information printed on the trading card at time of manufacture or by exploiting inherent characteristics, the card owner or dealer may readily ascertain the match of a given card with stored data and thereby know if that card is genuine and thus the true value of the trading card.

Cross reference is made to the following related applications incorporated by reference herein: Attorney Docket Number D/A2335Q entitled “System And Methodology For Authenticating And Providing Hidden Feature Information For Trading Cards And Other Printed Collectibles”, to inventor Michael A. Butler. Attorney Docket Number D/A2335Q1 entitled “System And Methodology For Custom Authenticating Trading Cards And Other Printed Collectibles”, to inventor Michael A. Butler.

### BACKGROUND

The present invention relates generally to trading cards for sports figures, baseball, action figures, etc. More particularly, this invention relates to validating the authenticity of such a trading card or other printed collectible.

Within the U.S. marketplace alone, collectors of trading cards (sports, Pokeman, etc) at the time of this writing, engage in approximately $400M of trading every year. Similar numbers are cited for European and Asia for card trading. Card memorabilia are traded over the Internet, at gatherings of collectors, via one-on-one transactions and at numerous small specialty shops or brokers around the country. One of the critical aspects of purchasing a trading card is receiving assurance that the card being offered is genuine. Today, traders and brokers rely upon various security features within a card in combination with a human expert to validate a card's authenticity. Security features can include foils, card stock, certain inks, etc. However, these features are often easily defeated. One of the fundamental requirements for the incorporation of any such security feature within a card, is accommodating the necessity which card manufacturers face of producing the cards incorporating any such security features at a very low cost.

The current method of trading card authentication is inspection by an expert. High-end cards currently use covert markings known only to those experts. Low-end cards that have become valuable to collectors may be authenticated by experts who are knowledgeable of certain identifiable characteristics, such as halftone screen, that are unique to, and associated with the production of the authentic cards. There is a fee charged by the expert for such service to the card owner. Engaging the services of such an expert is particularly difficult if none are located nearby. Even when an expert is nearby, there is a resultant impediment to card trading because of the location effort and time expenditure involved. As such, authentication is often reasonably neglected for the sake of expediency and accessibility. This in turn encourages the continued circulation in counterfeit cards to the unsuspecting, and thus discourages the legitimate flow of trade amongst the collecting public. It would be desirable to improve the level of assurance that can be provided to the card owner while otherwise minimizing the impact of utilizing experts for the authentication of trading cards.

In U.S. Pat. No. 5,959,281 to Domiteaux, the invention described discloses an interactive system for reading cards. The system comprises a card bearing an image and encoded information and a talking hand-held card reader for reading the encoded information on the card and playing back an audible message associated with the image or encoded information. In one aspect, the invention is also a talking hand-held card reader having a housing which is shaped to resemble a person, place, aspect or thing associated with the image or encoded information on the card being read.

In U.S. Pat. No. 5,579,117 to Arsenault, the invention described discloses a method for making a handleable card having images on front and back surface of the card. The process includes the creation of templates which incorporate a combination of design elements and repetitive textual information stored as computer files. These templates are combined with textual information specific to each card, as well as digital representations of scanned photographs, also stored as computer files. The resulting composite images are printed onto a single sheet material having front and back surface covered with plastic laminate film which has been treated with an adhesive layer on its inside surface. The covered sheet material is passed through laminator for fusing the front and back sheet material to the plastic laminate film and cut into separate card.

In U.S. Pat. No. 5,533,124 to Smith et al., the invention described discloses computer implemented trading cards. Trading card software is stored on a removable medium in a copy protected form. The trading card software includes trading card data and an executable computer program. Each removable medium contains trading card data that is specific to a particular individual or character or any other person, place, or thing. The trading card software is interactive. The computer user is able to select one of a number of predetermined displays by selecting interactivity areas on each display. A combination of copy protect schemes are utilized, including non-standard data formatting, encryption and sector modification. After use of the computer program is stopped, trading card data transferred to any storage device of the user's computer system during operation is then removed to prevent storing of the trading card data on any medium other than the removable medium.

In U.S. Pat. No. 5,282,651 to Alonso, the invention described discloses trading cards that are made interactive with the user by concealing under a coating the secondary indicia portion of an image comprising both primary and secondary indicia, and selectively altering the coating to reveal the secondary indicia in the presence of the primary indicia to complete the image. A thermochromic coating material responsive to temperature change from ambient temperature, as by rubbing the coating with the fingers, enables the local exposure of the secondary indicia.

All of the above are herein incorporated by reference in their entirety for their teaching.

Therefore, as discussed above, there exists a need for a system and methodology to minimize the impact of location effort and time expenditure involved for the confirmation of trading card authenticity. Thus, it would be desirable to solve this and other deficiencies and disadvantages with an improved methodology for authenticating trading cards.

The present invention relates to a method of authenticating trading cards and other printed collectibles. The method comprises printing a trading card with embedded code information; scanning the trading card to generate digital image data; extracting the embedded code information from the digital image data; comparing the extracted embedded code information to stored data in a profile repository; and, determining the authenticity of the trading card as based upon the comparison.

The present invention also relates to authenticating trading cards and other printed collectibles with a method that comprises scanning a trading card to generate a digital image data and extracting inherent characteristic information from the digital image data. The method further comprises comparing the extracted inherent characteristic information to stored data in a profile repository, and determining the authenticity of the trading card as based upon the comparison.

The present invention relates to a further method of authenticating trading cards and other printed collectibles. The method starts by printing a trading card with embedded code information. This is followed by scanning the trading card to generate digital image data. The digital image data is then manipulated, extracting inherent characteristic information from the digital image data and extracting the embedded code information. Then by comparing the inherent characteristic information and the extracted embedded code information to stored data in a profile repository, a determination of the authenticity of the trading card is made.

### BRIEF DESCRIPTION OF THE DRAWINGS

FIG. 1A depicts a suitable system arrangement for allowing at home verification for a trading card owner.

FIG. 1B depicts a typical present day generic trading card.

FIG. 2 provides an operation chart of an alternative scenario for certified dealer service access employing the system of FIG. 1A.

FIG. 3 shows one possible arrangement for the embedding of authenticating information into the image data for a trading card.

FIG. 4 shows how authentication information may be embedded into a design element.

FIG. 5A depicts the use of a patterned transparency as placed upon a suitably encoded trading card to reveal authentication information.

FIG. 5B provides a magnification of the authentication pattern of FIG. 5A

FIG. 6 depicts a flow chart for authentication and revealing hidden features information for the at home trading card owner.

FIG. 7 shows a system for providing custom card creation.

### DESCRIPTION

Herein is proposed a system and method for validation and confirmation of trading card validity. By providing suitable embedded code as authentication information, printed on the trading card at time of manufacture the card owner or dealer may readily ascertain the match of a given card with stored data and thereby know if that card is genuine and thus the true value of the trading card.

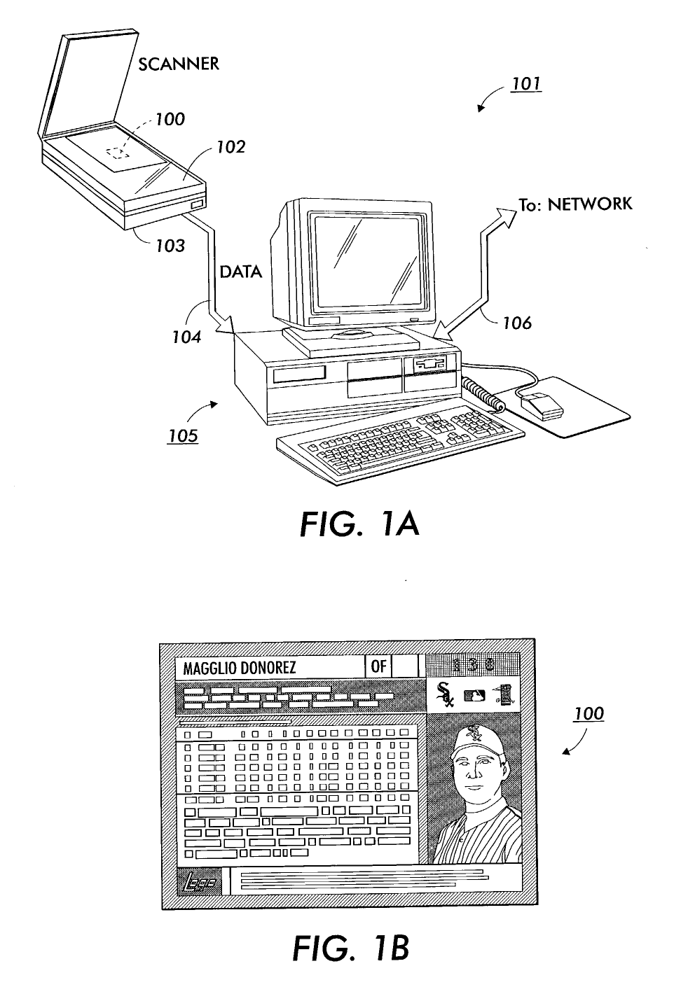

FIG. 1B shows a depiction of a typical present day generic trading card 100. FIG. 1A depicts one embodiment of a system 101 suitable for operating to the methodology disclosed herein. Using a scanner 102, a trading card 100 is placed upon the scanner platen 103, and by invoking the scanner 102 digital image data 104 is provided to computer system 105. The trading card 100 may, of course, be scanned at multiple resolutions and in different modes to facilitate multi-mode analysis of the card. The computer system 105 is provided with a network connection 106 of some variety. Such an arrangement could allow at home verification for a trading card owner. In such a scenario, the trading card owner may access software to allow comparison of the image data 104 with authentication information provided from the trading card company via the network 106 from a company database.

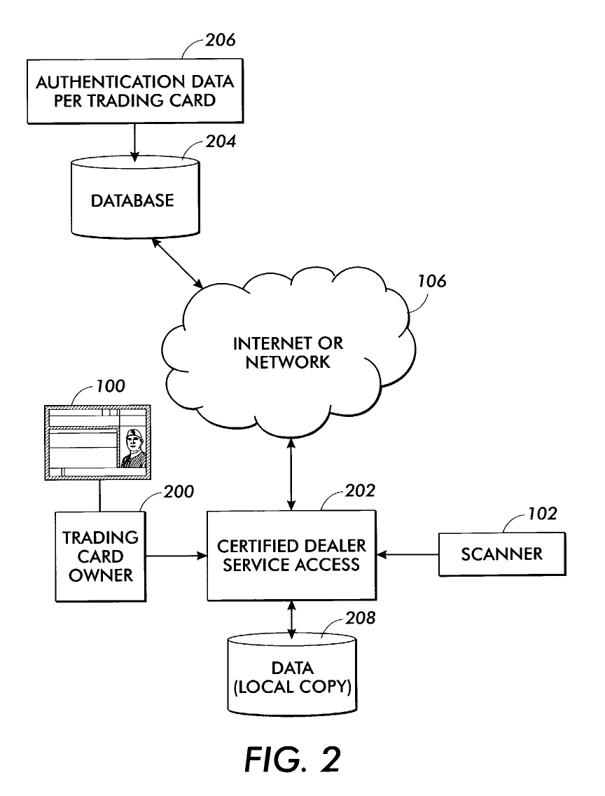

FIG. 2 provides an operation chart for an alternative scenario still employing system 101. However in this scenario the system 101 is employed in situ with the trading card dealer's site of operation. A trading card owner 200 brings his trading card 100 to a certified dealer having service access 202. The card 100 is again scanned with scanner 102 for authentication at the dealer's place of business. Here one of two possible paths may be taken. One arrangement has the dealer system 101 connect via a network or Internet connection 106 to a trading card profile repository provided by the trading card manufacturer. This profile repository is most typically a database 204 into which the manufacturer has provided the authentication data 206. However, given the possible voluminous nature of the data, another path maybe that the desired authentication data 206 may have been background loaded into a local database 208 prior to the owners arrival. Indeed as will be well understood by those skilled in the art, the local database 208 may be a copy (or shadow drive) of the manufacturer's database 204. This local copy may be updated on a periodic basis to reflect changes made to the manufacturer's database, with updates made via either automatic or manual processes.

There are two expected basic trading card 100 type possibilities to be accounted for: older existing cards; and trading cards printed in contemplation of the authentication methodology provided herein as described below. For the older pre-existing cards, scan data may be scrutinized for a number of inherent characteristics comprising for example: spectral characteristics as based upon the inks used in the printing of the trading card; or where there are signatures by performing signature analysis; or by identification of specific halftone structures or registration characteristics. These techniques may be use singly or in combination. As an example, a simplified spectral analysis can be performed taking advantage of color management technology which is now prevalent even in low cost scanners and incorporated in common offered computer operating systems. Using known principles of color management it is possible to compare the tri-stimulus values and calibrated RGB scanner outputs from several predetermined portions of a trading card with information stored in the database for those same pre-determined areas and thereby assign a probability that the card is authentic. Similar approaches can be used for analysis based upon other common image characteristics such as halftone screen or registration between pre-determined graphical elements printed on the trading card.

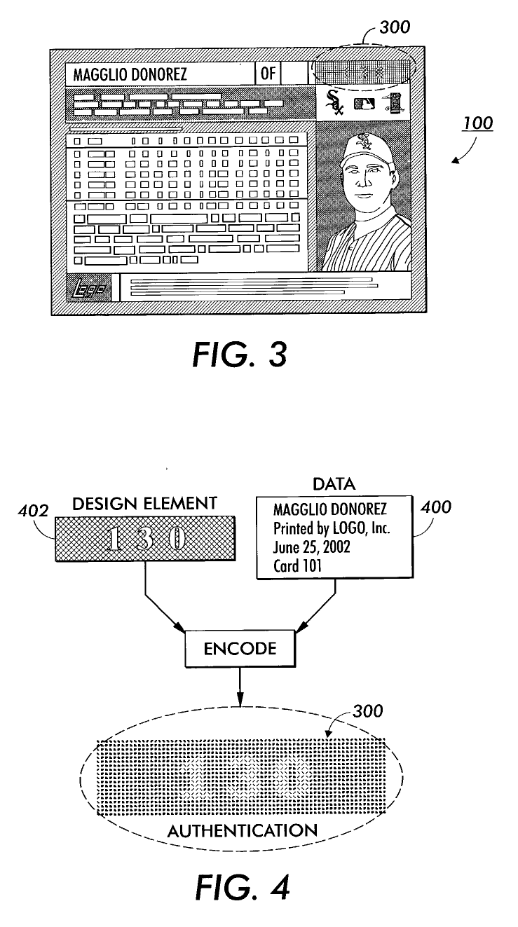

Another expected basic trading card type is one created in contemplation of subsequent authentication in a scanning system as described above. It is thereby desirable to provide some data in the trading card in expectation of authentication. In FIG. 3 there is shown one example of trading card authentication segment 300 as embedded into image data for a trading card 100, which when printed will provide a secure trading card. FIG. 4 depicts one example embodiment for the assemblage of image data to yield authentication segment 300 utilizing in this example dataglyphs. Authentication information 400 is merged with design element data 402, therein encoding authentication information 400 to yield authentication segment 300. Authentication information 400 may be the exact equivalence of the authentication data 206. However, it is entirely within the contemplation of this invention that there are alternatives where the authentication information 400 is a subset of the authentication data 206 or vice versa. For example, authentication data 206, as provided in a profile repository, may contain all of authentication information 400 but also contain addition data relating to the subject trading card such as the size, print date, distribution, card content and card specific information that can be used to identify a unique card or set of cards. It is also comprehended by this invention that encoded authentication information 400 may be represent a code or other abstract information that is compared to authentication data 206 to authenticate a trading card. Such additional information may also be applied in combination with authentication information 400 for authenticating a trading card.

There are a number of ways in which authentication information 400 may be encoded into a card image data or design element 402. These may comprise, for example, one-dimensional symbologies, two-dimensional symbologies, dataglyphs, digital watermarks, or glossmarks, either singly or in combination. One-dimensional symbologies, such as bar codes, and two-dimensional symbologies, such as PDF417 are well known to those skilled in the art. The utilization of dataglyphs is taught in U.S. Pat. Nos. 5,448,375, 5,459,307, and 5,486,686 all of which are herein incorporated by reference for their teaching. Digital watermarking is taught in U.S. Pat. Nos. 5,734,752, 5,790,703, 6,252,971, and 6,263,086, all of which are herein incorporated by reference for their teaching. Application of glossmarks is provided in U.S. patent application Ser. Nos. 10/159,423, 10/159,432, 10/186,065, and attorney docket number D/A1745 which are herein incorporated by reference for their teaching. As depicted in FIG. 4 the data 400 is encoded by rendering the design element 402 with dataglyphs.

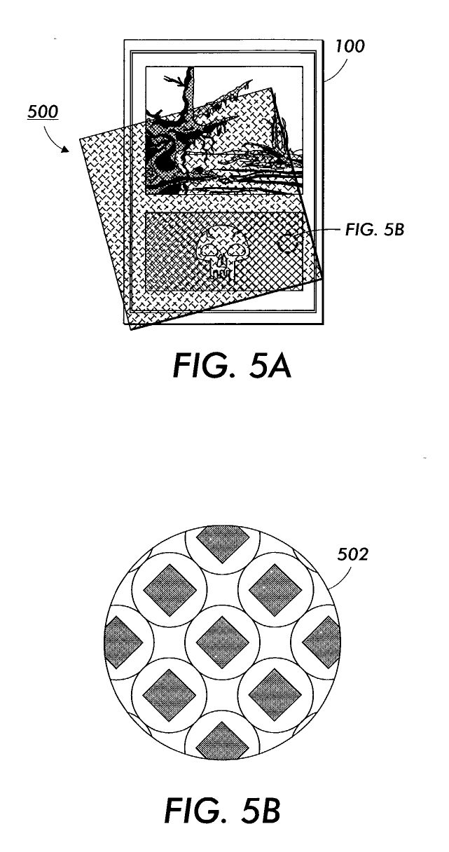

An alternative method of detecting authentication information encoded into a card image or design element is depicted in FIG. 5A. In FIG. 5A, there is depicted the superimposition of a patterned transparency 500 as a simple validation tool for placement over a trading card 100. The card 100 and the transparency 500 have been suitably arranged as to provide correlated halftone screens known as digital watermarks or printermarks. The transparency 500 is manually slipped about in contact and superimposition over the card 100 until the authentication information 400 is visible. Digital watermarks as printermarks are taught in U.S. Pat. Nos. 5,734,752, 5,790,703, 6,252,971, and 6,263,086 which are herein incorporated by reference for their teaching. FIG. 5B depicts a close-up of the provided data 502. The data so provided may be used for more than authentication. It may provide the card holder with hidden features information including some indication of winnings. In further alternatives, the hidden features information may provide some other novelty marking or indication of value as a collectable.

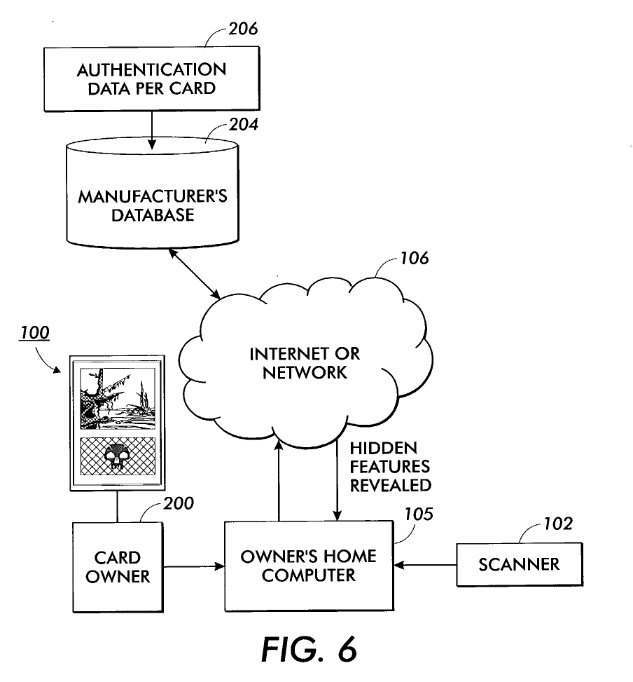

FIG. 6 expands the hidden features aspect of FIG. 5A beyond the use of a handheld tool and extends it into the home of a card owner 200 by further applying embedding techniques like glossmarks, dataglyphs, and digital watermarks which can be scanned. The card owner 200 downloads special software from the manufacturer's database 204 over the internet 106 to his computer 105. The hidden features software download is invoked and the card owner 200 places the trading card 100 upon the scanner 102. The hidden features software thereupon scans, extracts, and displays the hidden features information from the card, possibly using information that is stored in the manufacturer's site.

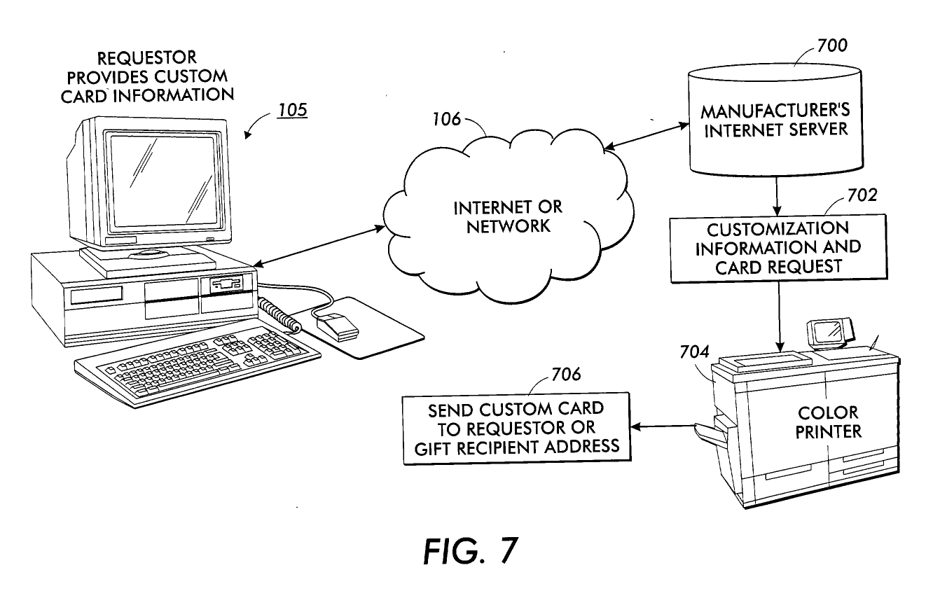

FIG. 7 shows a system and methodology flow for allowing consumer customized trading cards. A consumer or business dealership employing a computer system 105 is allowed to remotely access, such as via the Internet 106, a manufacturer's site on their Internet server 700. There the requesting consumer may select and order a custom card. The card for example may have custom glossmark embossing, or personalized information such as their name or photograph that is encoded on the trading card using dataglyphs, digital watermarks or some other encoding scheme. By producing customized cards in response to a customer order, the manufacture is able to create unique cards, with high personal value and offer a larger range of designs, with the most up to date information about athletes or collectable characters without incurring the costs of maintaining a large inventory or disposing out of date cards. The manufacturer can further make the cards more valuable by offering a limited production of cards, such as limiting them by date, or the total number of cards produced, possibly making them available via auction only to the highest bidder.

When creating a card with information encoded using digital watermarks, it is possible to print a transparency 500 that can be used by the recipient to decode the customized message. The printed transparency can be designed to be relatively unique to the card, in the sense that there is a relatively large set of possible halftone screens and corresponding decoding patterns that can be chosen when printing any given card. It is envisioned that a customized card could become valuable as a collectable due to subsequent circumstances such as their creation date coinciding with some particular event, such as the setting of a major athletic record, or due to the provenance of the card, such as the recipient or sender later achieving notoriety or fame. To support the dual objectives of customization and authentication, the manufacturer may encode certain authentication information in the card that is otherwise known only to the manufacturer and store such information in the manufacturer's database 204 along with a description of date of manufacture, sender, recipient, customization information and other such information as may be useful to establish value as a collectable. There are many examples of personalized information such as the consumer's name or photograph, a scanned signature provided by the recipient, a digitally rendered signature using a font based upon the actual signature of a real or fictitious character, or a graphic for encoding on the trading card. The card may be for the requester, a friend or relative. The customization information 702 is then passed under software control to a digital press or suitable color printer 704 for printout. The resulting custom card is then sent to the requestor or gift recipient 706 directly.

In closing, by providing properly embedded data within the image data for a trading card as well as making advantage of salient card artifacts, a dealer or consumer when enabled by suitable system and software may readily establish trading card authenticity with much greater ease and at considerably lower cost than with methodologies presently available.

While the embodiments disclosed herein are preferred, it will be appreciated from this teaching that various alternative modifications, variations or improvements therein may be made by those skilled in the art. Examples of objects that would be covered by these methods include stamps, postcards, posters, CD's and other printed collectibles. All such variants are intended to be encompassed by the following claims:

1. A method of authenticating trading cards and other printed collectibles comprising:
printing a trading card with embedded code information;
scanning the trading card to generate digital image data;
extracting the embedded code information from the digital image data;
comparing the extracted embedded code information to stored data in a profile repository; and,
determining the authenticity of the trading card as based upon the comparison.

2. The method of claim 1 wherein the code information has been embedded and extracted using dataglyphs.

3. The method of claim 1 wherein the code information has been embedded and extracted using digital watermarks.

4. The method of claim 1 wherein the code information has been embedded using an encoding from the group of one-dimensional and two-dimensional symbologies.

5. The method of claim 1 wherein the code information has been embedded and extracted using a combination of dataglyphs and digital watermarks.

6. The method of claim 2 wherein the profile repository is located remotely.

7. The method of claim 3 wherein the profile repository is located remotely.

8. The method of claim 4 wherein the profile repository is located remotely.

9. The method of claim 5 wherein the profile repository is located remotely.

10. The method of claim 2 wherein the profile repository is located locally.

11. The method of claim 3 wherein the profile repository is located locally.

12. The method of claim 4 wherein the profile repository is located locally.

13. The method of claim 5 wherein the profile repository is located locally.

14. A method of authenticating trading cards and other printed collectibles comprising:
scanning a trading card to generate a digital image data;
extracting inherent characteristic information from the digital image data;
comparing the extracted inherent characteristic information to stored data in a profile repository; and,
determining the authenticity of the trading card as based upon the comparison.

15. The method of claim 14 wherein the extracted inherent characteristic information comprises spectral characteristics.

16. The method of claim 14 wherein the extracted inherent characteristic information comprises a signature for signature analysis.

17. The method of claim 14 wherein the extracted inherent characteristic information comprises registration characteristics.

18. The method of claim 14 wherein the extracted inherent characteristic information comprises halftone structure characteristics.

19. The method of claim 15 wherein the profile repository is located remotely on a manufacturer's internet site.

20. The method of claim 16 wherein the profile repository is located remotely on a manufacturer's internet site.

21. The method of claim 17 wherein the profile repository is located remotely on a manufacturer's internet site.

22. The method of claim 18 wherein the profile repository is located remotely on a manufacturer's internet site.

23. A method of authenticating trading cards and other printed collectibles comprising:
printing a trading card with embedded code information;
scanning the trading card to generate digital image data;
extracting inherent characteristic information from the digital image data;
extracting the embedded code information from the digital image data;
comparing the inherent characteristic information and the extracted embedded code information to stored data in a profile repository; and,
determining the authenticity of the trading card as based upon the comparison.

24. The method of claim 23 wherein the code information has been embedded and extracted using digital watermarks.

25. The method of claim 23 wherein the code information has been embedded and extracted using an encoding from the group of one-dimensional and two-dimensional symbologies.

26. The method of claim 23 wherein the code information has been embedded and extracted using dataglyphs.

27. The method of claim 26 wherein the extracted inherent characteristic information comprises spectral characteristics.

28. The method of claim 26 wherein the extracted inherent characteristic information comprises halftone structure characteristics.

29. The method of claim 26 wherein the extracted inherent characteristic information comprises registration characteristics.
